(19) United States
(12) Patent Application Publication
(10) Pub. No.: US 2016/0090522 A1
(43) Pub. Date: Mar. 31, 2016

(54) FLEXIBLE HEAT-DISSIPATING COMPOSITE SHEET INCLUDING FILLER AND LOW-VISCOSITY POLYMERIZABLE THERMOPLASTIC RESIN AND COST EFFECTIVE MASS PRODUCIBLE METHOD FOR PREPARING THE SAME

(71) Applicant: KOREA INSTITUTE OF SCIENCE AND TECHNOLOGY, Seoul (KR)

(72) Inventors: Seong Yun KIM, Wanju-gun (KR); Ye Ji NOH, Wanju-gun (KR); Cheol-Min YANG, Wanju-gun (KR)

(73) Assignee: KOREA INSTITUTE OF SCIENCE AND TECHNOLOGY, Seoul (KR)

(21) Appl. No.: 14/616,074

(22) Filed: Feb. 6, 2015

(30) Foreign Application Priority Data
Sep. 30, 2014 (KR) 10-2014-0131625

(51) Int. Cl. C09K 5/14; B32B 27/36; B32B 27/08

(52) U.S. Cl. CPC C09K 5/14; B32B 27/08; B32B 27/36; B32B 2250/02; B32B 2250/244; B32B 2255/10; B32B 2255/26; B32B 2307/302

(57) ABSTRACT

A flexible heat-dissipating sheet including a composite layer of filler and polymer resin is provided. The heat-dissipating sheet is obtained by dispersing a polymerization catalyst in a polymerizable thermoplastic resin and blending them with each other to form a thermoplastic resin composition, and mixing fillers with the thermoplastic resin composition, applying the resultant mixture onto a substrate film, followed by heating to carry out in-situ polymerization and to allow the composite layer of fillers and thermoplastic resin to be adhered to the substrate film. The heat-dissipating sheet has excellent heat-dissipating properties, i.e. heat conductivity, particularly in-plane heat conductivity, and shows improved physical properties, including mechanical properties and thermal properties, etc.

### CROSS-REFERENCE TO RELATED APPLICATION

This application claims priority to Korean Patent Application No. 10-2014-0131625, filed on Sep. 30, 2014, and all the benefits accruing therefrom under 35 U.S.C. §119, the contents of which in its entirety are herein incorporated by reference.

### BACKGROUND

1. Field

The present disclosure relates to a flexible heat-dissipating composite sheet including filler and low-viscosity polymerizable thermoplastic resin and a cost effective mass producible method for preparing the same.

2. Description of the Related Art

After carbon nanotube was first discovered by Ijima, studies have been conducted on polymer resin composites which utilize superior physical properties of the carbon nanotubes. Although various composites exhibiting good physical properties of carbon nanotube were developed and reported in laboratory scale, large scale production and distribution of the composites have not yet met the expectation.

Specifically, the dispersion characteristics of carbon nanotubes which tend to aggregate due to van der Waals' interaction are controlled relatively well by chemical and physical methods in laboratory scale. However, as the scale becomes large, the process cost also increases sharply and further the dispersion of carbon nanotube is not controlled well due to various limitations such as time, etc. As a result, non-uniform and incomplete contact between the carbon nanotubes often occurs.

Since it is not easy to control the dispersion characteristics of carbon nanotubes especially when polymer resin composites including carbon nanotubes are produced in large scale, such useful physical properties of the carbon nanotube are not able to be fully expressed in the composite. Accordingly, it is difficult to obtain expected excellent thermal and other properties of the composite.

Meanwhile, in 2004, Andre Geim and his colleagues at the University of Manchester isolated single-layered graphene, which had been known to be thermodynamically unstable and unable to exist at room temperature. Since then, interests in graphene have grown.

Compared with other existing carbon materials, graphene has wider surface area, is very superior in mechanical strength and thermal/electrical properties, and has flexibility and transparency. Due to these superior mechanical, electrical and thermal properties, etc. of graphene, a polymer composite including graphene may have remarkably improved physical properties. In addition, since graphene exhibits superior gas barrier property owing to its structural features, polymer composites including graphene have been drawing attractions in various applications, including electronic devices, energy storage media, organic solar cells, heat-insulating materials, film packaging materials, biomimetic devices, or the like.

However, when preparing a polymer composite including graphene, particularly nanographene, it is difficult to achieve uniform dispersion of graphene in the polymer resin because of, for example, rapid increase in viscosity of the polymer resin during mixing. Accordingly, achieving the superior physical properties expected for the composite was actually difficult.

In particular, if graphene is not uniformly dispersed in the polymer resin and fails to bond at the interface with the resin, the graphene becomes aggregated. To this end, the physical properties of the composite become rather worse due to cracks, pores and pinholes, etc.

The conventional method for preparing a polymer resin composite by compounding fillers such as micro or nano sized fine fillers, for example, metal filler, ceramic filler or carbon filler, in particular, nanocarbon such as carbon nanotube or nano graphene, etc. with a polymer resin has limitation in increasing the content of the fillers while dispersing the fillers. As a result, the content of the fillers in such composite has not reached to about 30 wt %.

Further, even a polymer resin composite where the filler content is about 20-30 wt %, which is relatively at a highest level in the conventional polymer resin composites, exhibits unsatisfactory physical properties resulting from the poor dispersing including aggregation etc. and non-uniform and incomplete contact between the fillers as well as the low filler content.

To solve the above-mentioned problems, methods for continuation of highly conductive materials have been developed, and examples thereof may include bucky paper obtained by continuation of carbon nanotubes and reduced graphene oxide paper (rGO paper) obtained by reduction and continuation of graphene oxide, etc. Such continuated materials may be commercialized in the form of composite films or sheets through impregnation of the continuated materials in a polymer resin. However, in this case, despite their improved mechanical, electrical and thermal characteristics of the resultant products, high processing cost, particularly high cost resulting from the continuation of highly conductive materials which is not amenable to mass production, limits their practical industrial application.

### SUMMARY

The present disclosure is directed to a heat-dissipating sheet including a composite layer of polymer resin and filler, such as metallic filler or ceramic filler, or carbon filler, particularly nanocarbon such as carbon nanotubes or nano-graphene, and a method for preparing the same. According to the present disclosure, it is possible to provide a heat dissipating sheet which may include a highly conductive composite layer that may contain a high content of filler of at least 30 wt %, and as well it is possible to reduce the problems occurring when producing the composite of polymer resin and such a high content of filler (particularly, in case of mass production), such as poor filler dispersion, filler agglomeration and/or incomplete contact between fillers. In addition, the composite layer may be adhered with ease to a wide-use film (resin film) without any additional processes, and the heat-dissipating sheet may have excellent heat-dissipating properties, for example, high heat conductivity, particularly in-plane heat conductivity.

In some embodiments, there is provided a method for preparing a heat-dissipating sheet including a composite layer of filler and polymer resin, including: dispersing a polymerization catalyst in a polymerizable thermoplastic resin and blending them to form a thermoplastic resin composition; and mixing fillers with the thermoplastic resin composition, applying the resultant mixture onto a substrate film, followed by heating to carry out in-situ polymerization and to allow the composite layer of filler and thermoplastic resin to be adhered to the substrate film.

According to an example embodiment, the substrate film may be a film consisting essentially of a resin compatible with the thermoplastic resin.

According to an example embodiment, it is preferable to mix a thermoplastic resin composition in powder form with fillers in powder form.

According to an example embodiment, the fillers may be present in an amount of 10-95 wt %, specifically 30-95 wt % or 50-95 wt % based on the composite layer of filler and polymer resin.

According to an example embodiment, the method may include melting the thermoplastic resin so that it is impregnated into the fillers, and carrying out heating at a temperature ranging from a temperature where the polymerization of thermoplastic resin starts to a temperature below a thermal decomposition temperature of thermoplastic resin.

According to an example embodiment, hot pressing may be carried out by applying pressure in the heating.

According to an example embodiment, the thermoplastic resin may be polybutylene terephthalate (PBT) and the resin of substrate film may be polyethylene terephthalate.

According to an example embodiment, the polymerizable thermoplastic resin may be cyclic butylene terephthalate (CBT), and the in-situ polymerization is carried out in a mold after introducing the substrate film, on which the mixture of the fillers with the thermoplastic resin composition is applied, to the mold, wherein the mold is heated to a temperature of 150-260° C. within a time greater than 0 second to 30 seconds, maintained at the temperature for a time of 1 minute to 24 hours, and then cooled to a room temperature within a time greater than 0 second to 60 seconds.

According to an example embodiment, the polymerization catalyst may be titanium tetraoxide (TiO₄).

According to an example embodiment, the fillers may be at least one selected from the group consisting of metallic fillers, ceramic fillers and carbon fillers.

According to an example embodiment, the fillers may be nanocarbons.

According to an example embodiment, the nanocarbons may be at least one selected from the group consisting of carbon nanotubes (CNT), nano-graphenes and nano-graphene oxides (GO), or at least one selected from the said nanocarbons group and subjected to heat treatment, hydrogen peroxide treatment and regal water treatment.

In some other embodiments, there is provided a heat-dissipating sheet including a composite layer of filler and polymer resin, including: a substrate film; and a composite layer provided on the substrate film and containing fillers and polymer resin, wherein the polymer resin may be a polymer of a polymerizable thermoplastic resin, and the polymerizable thermoplastic resin has a property of decreasing in melt viscosity during a polymerization.

According to an example embodiment, the heat-dissipating sheet may include the composite layer interposed between two substrate films.

According to an example embodiment, the fillers may be included in an amount of 10-95 wt %, specifically 30-95 wt % or 50-95 wt % based on the composite layer of filler and polymer resin.

According to an example embodiment, the heat-dissipating sheet may have a 2% or less filler composition uniformity.

According to an example embodiment, the substrate film may consist essentially of a resin compatible with the polymer resin.

According to an example embodiment, the heat-dissipating sheet has an interdiffused phase consisting of the polymer resin and a resin of the substrate film between the composite layer and the substrate film.

According to an example embodiment, the polymer resin may be polybutylene terephthalate (PBT) and a resin of the substrate film may be polyethylene terephthalate.

According to an example embodiment, the fillers may be at least one selected from the group consisting of metallic fillers, ceramic fillers and carbon fillers, particularly carbon fillers.

According to an example embodiment, the fillers may be nanocarbons.

According to an example embodiment, the fillers may be powdery fillers (fillers in powder form).

According to an example embodiment, the substrate film may be a flexible substrate film.

According to an example embodiment, the heat-dissipating sheet may have a heat conductivity of at least 20 W/m·K.

According to an example embodiment, the heat-dissipating sheet may have a tensile strength of at least 200 MPa.

According to the present disclosure, when producing a heat-dissipating sheet including a composite layer of filler and polymer resin on or between films (particularly, in case of mass production thereof), it is possible for the fillers to be incorporated at a high content of at least 30 wt % or 50 wt % based on the composite layer of filler and polymer resin. Further, even when the fillers are incorporated at such a high content, the fillers may be dispersed homogeneously with ease and the fillers may contact with each other well while at the same time inducing an adhesion of the composite layer to a substrate film (resin film). As a result, it is possible to produce a heat-dissipating sheet efficiently. In addition, according to the heat-dissipating sheet including a composite layer of filler and polymer resin on or between films, it is possible to provide excellent heat-dissipating properties, i.e. heat conductivity, particularly in-plane heat conductivity, and to improve the overall physical properties, such as mechanical properties and thermal properties, etc.

### BRIEF DESCRIPTION OF THE DRAWINGS

FIG. 1 is a schematic view illustrating a method for preparing a heat-dissipating sheet including a composite layer of filler (e.g. nanocarbon) and resin (e.g. CBT) between films (e.g. wide-use PET films) according to an example embodiment.

FIGS. 2A and 2B illustrate photographs of the heat-dissipating sheets prepared according to Example.

### DETAILED DESCRIPTION

Example embodiments now will be described more fully hereinafter with reference to the accompanying drawings, in which example embodiments are shown. The present disclosure may, however, be embodied in many different forms and should not be construed as limited to the example embodiments set forth therein. Rather, these example embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Furthermore, the use of the terms a, an, etc. do not denote a limitation of quantity, but rather denote the presence of at least one of the referenced item. The terms “first,” “second,” and the like do not imply any particular order, but are included to identify individual elements. Moreover, the use of the terms first, second, etc. do not denote any order or importance, but rather the terms first, second, etc. are used to distinguished one element from another.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

As used in the present disclosure, the term polymerizable thermoplastic resin refers to a thermoplastic resin whose viscosity decreases when heated and melted, and is polymerized into a polymer resin if further heated.

As used in the present disclosure, the term in-situ polymerization refers to a reaction where a polymerizable thermoplastic resin is melted and polymerized into a polymer resin by heating.

As used in the present disclosure, the term metal fillers refer to fillers made of metal.

As used in the present disclosure, the term ceramic fillers refer to fillers made of ceramic.

As used in the present disclosure, the term carbon fillers refer to fillers made of carbon-based materials (for example, graphite, carbon fiber, etc.)

As used in the present disclosure, the term nanocarbons refer to carbon-based materials which have a nano-scale size (1000 nm or smaller) and is capable of bonding at its molecular level (for example, carbonanotubes, nano graphenes, etc.)

According to example embodiments, a polymerization catalyst and a polymerizable thermoplastic resin are subjected to dispersion and mixing to provide a composition (specifically, a powdery composition), the resultant composition is mixed with fillers (specifically, powdery fillers), the resultant mixture is applied onto a substrate film (specifically, a resin film compatible with the thermoplastic resin), and then in-situ polymerization is carried out so that at the same time the mixture is adhered to the film, thereby providing a heat-dissipating sheet including a composite layer of filler and polymer resin. The heat-dissipating sheet may have flexibility.

Accordingly, even when such flexible heat-dissipating sheet including a composite layer of filler and polymer resin is produced, in particular, mass-produced, it is possible for the heat-dissipating sheet to contain fillers at a high content of at least 30 wt %. In addition, the problems of dispersion such as agglomeration and non-uniform and incomplete contact between the fillers, etc. may be reduced even at such high content of the fillers, and it is possible to obtain a heat-dissipating sheet including a composite of filler and polymer resin having remarkably improved physical properties such as mechanical, thermal and electrical properties, etc., particularly the thermal properties.

A method for preparing a heat-dissipating sheet including a composite of filler and polymer resin according to example embodiments may include: dispersing a polymerization catalyst in a polymerizable thermoplastic resin and blending them with each other to form a thermoplastic resin composition; and mixing fillers (specifically, powdery fillers) with the thermoplastic resin composition (specifically, powdery thermoplastic resin composition), applying the resultant mixture onto a substrate film (specifically, a resin film compatible with the thermoplastic resin), followed by heating to carry out in-situ polymerization and to allow the composite layer of the fillers and thermoplastic resin to be adhered to the substrate, thereby providing a flexible heat-dissipating sheet including a composite layer of filler and polymer resin. In this manner, it is possible for the fillers to be inserted and distributed homogeneously between the polymer resin and the resin of substrate film.

Hereinafter, each steps of the method will be described in detail. The embodiments using nanocarbons are mainly explained below in that the present disclosure is usefully applied to nanocarbons since among the fillers, nanocarbons are especially difficult to be included at high contents and high degree dispersions of nanocarbons are especially difficult. However, it will be understood that the embodiments of the present disclosure are not limited to nanocarbons, but rather applicable to all other fillers, for example, micro sized fillers as well as nano sized fillers and other kinds of fillers (e.g. metal fillers, ceramic fillers) as well as carbon based fillers. Further, a combination of two or more of the fillers may be used.

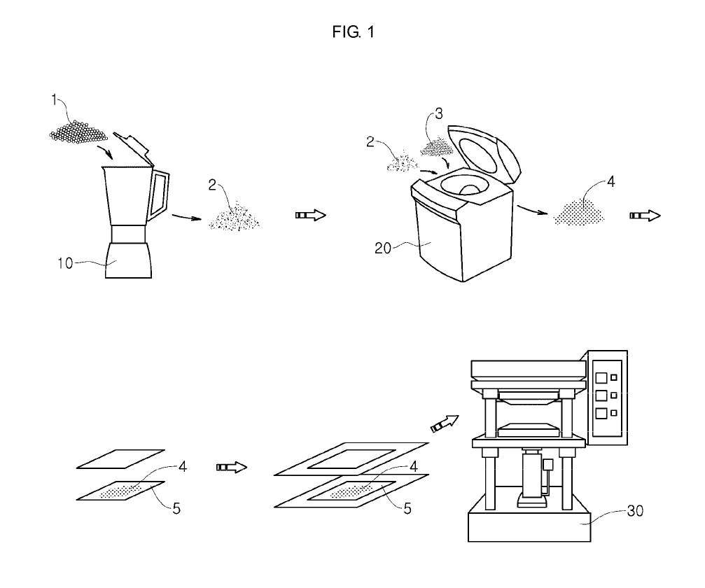

FIG. 1 is a schematic view illustrating a method for preparing a heat-dissipating sheet including a composite layer of filler (e.g. nanocarbon) and resin (e.g. CBT) between films (e.g. wide-use PET films) according to an example embodiment.

Referring to FIG. 1, in an example embodiment, a polymerizable thermoplastic resin and a polymerization catalyst 1 (The thermoplastic resin and the polymerization catalyst are denoted by 1 in FIG. 1) are first dispersion-mixed using, for example, a mixer 10 to prepare a thermoplastic resin composition 2.

The polymerizable thermoplastic resin may have a low melt viscosity so that it may easily be introduced and impregnated into the nanocarbons during the following preparation of the heat-dissipating sheet.

That is, the polymerizable thermoplastic resin may have a low melt viscosity of tens to hundreds of cps. For example, a cyclic butylene terephthalate (CBT) or caprolactam may be used. Oigomer type resin may also be used. The CBT resin may become a polybutylene terephthalate (PBT) resin after polymerization, the caprolactam resin may become a polyamide resin (nylon resin) after polymerization. The oligomer resin may become a polymer resin after polymerization. Particularly, the PBT or polyamide resin is suitable for a composite owing to superior heat resistance and mechanical strength.

Although the thermoplastic resin may be in a powder or pellet form, it is preferable that the thermoplastic resin is in a powder form in that in-situ polymerization after powder mixing is specifically desirable in dispersing a high content of fillers (e.g. nanocarbons) at a high degree during the preparation of the heat-dissipating sheet. Further, for the same reason, powdery fillers are also preferable.

The polymerization catalyst is mixed with the polymerizable thermoplastic resin and constitutes the thermoplastic resin composition. It is used to induce and facilitate the polymerization of the thermoplastic resin.

In an example embodiment, titanate, stannoxane, etc. may be used as the polymerization catalyst. Particularly, titanium tetroxide (TiO₄) may be used.

The polymerization catalyst may be included in the thermoplastic resin composition in an amount of, for example, about 0.02-1 mol %, more specifically, for example, about 0.5 mol %.

The prepared thermoplastic resin composition 2 is mixed with nanocarbons 3 using, for example, a Thinky mixer 20, etc. and the resultant mixture 4 is applied onto the substrate film 5 (e.g. between two substrate films).

The polymerizable thermoplastic resin in the mixture of nanocarbons 3 with the thermoplastic resin composition 2 decreases in viscosity significantly during melting, which allows impregnation of the polymerizable thermoplastic resin into the nanocarbons and thus allows homogeneous dispersion of the nanocarbons while at the same time the polymerizable thermoplastic resin is allowed to be interdiffused to a resin of the substrate film, particularly, a resin film where the resin is compatible with the thermoplastic resin. As a result of the interdiffusion, the heat-dissipating sheet may have an interdiffused phase (interdiffused phase consisting of the polymer resin and the resin of the substrate film) between the composite layer and the substrate film.

A wide-use flexible substrate film may be used as the substrate film. In addition, the resin of the substrate film may be one compatible with the thermoplastic resin. For example, as for the resin of the substrate film, a polyethylene terephthalate film compatible with the above-mentioned PBT may be used.

Even when nanocarbons are included at a high content of at least 30 wt % or 50 wt %, nanocarbons may be well dispersed and thus poor contact between nanocarbons may be prevented. Thus, it is possible to improve the physical properties of the composite sheet.

In an example embodiment, the fillers used in combination with the thermoplastic resin is not limited in terms of the material thereof, but may be at least one selected from the group consisting of metallic fillers, ceramic fillers and carbon fillers. Particularly, the filler may be a carbon filler.

The carbon filler may be a micrometer-size carbon filler but may be nanocarbons. As described above, in case of fillers such as, in particular, nanocarbons such as carbon nanotubes or nano-graphenes etc., it may be more difficult to be incorporated in a composite material at a high content while accomplishing high dispersibility. However, such a problem may be solved according to the present disclosure.

For example, the heat dissipating sheet obtained according to the example embodiments may have a filler composition uniformity. That is, supposed that the included fillers content is Awt %, the fillers included in arbitrary unit volume of composite layer of the heat dissipating sheet may be within 2% of Awt % [i.e., A±(A×0.02) wt %]. This is defined as 2% or less filler composition uniformity in this disclosure. Explaining more concretely, for example, if filler content is 30 wt % based on a composite layer (for example, 10 cm×10 cm×t μm) in the heat dissipating sheet, filler content measured in arbitrary unit volume (for example, 1 cm×1 cm×t μm) may be 30±0.6 (30×0.02=0.6) wt %.

In an example embodiment, the nanocarbons may be at least one selected from the group consisting of carbon nanotubes (CNT), nano-graphene and nano-graphene oxides. In addition, the nanocarbon may be nanocarbons, such as carbon nanotubes, graphene or graphene oxide subjected to heat treatment, hydrogen peroxide treatment or regal water treatment.

In an example embodiment, the nanocarbons may be preferably powdery nanocarbons in order to disperse nanocarbons homogeneously in the final composite sheet.

Methods for mixing the thermoplastic resin composition with nanocarbon are not limited, as long as they allow homogeneous mixing of the thermoplastic resin composition with nanocarbons.

In an example embodiment, the mixing may be carried out by using a thinky mixer or ball mill.

After mixing, in-situ polymerization is carried out. That is, the mixture 4 of thermoplastic resin composition 2 with nanocarbon 3 is applied onto a substrate film 5, particularly a substrate film 5 compatible with the thermoplastic resin, and the resultant laminate is introduced to a polymerization reactor 30 to carry out in-situ polymerization, thereby providing a flexible heat-dissipating sheet including a composite layer, which contains nanocarbons and polymer resin. Through the in-situ polymerization, as described above, the polymer resin is introduced and impregnated into nanocarbons, and to this end it is possible to obtain a flexible heat-dissipating sheet in which nanocarbons are dispersed homogeneously.

The polymerization of the polymerizable thermoplastic resin occurs quickly at high temperatures and slowly at low temperatures. Accordingly, heating is performed to a polymerization starting temperature or higher and below a thermal decomposition temperature of the thermoplastic resin. Specifically, the polymerizable thermoplastic resin may be heated to the polymerization starting temperature in a short time, maintained at the polymerization starting temperature or higher and below the thermal decomposition temperature of the thermoplastic resin for a predetermined time, and then cooled rapidly.

For example, the CBT resin is melted around 130° C. and polymerization begins at about 150° C. or higher. Although the polymerization occurs faster at higher temperatures, thermal decomposition may occur above about 260° C. Accordingly, the CBT resin is heated to the corresponding temperature range (e.g., about 150-260° C.) in a short time (e.g., in about 0-30 seconds), maintained at the temperature for a predetermined time (e.g., for about 1 minute to about 24 hours, it is preferable to reduce this time as much as possible), and then cooled to rapidly (e.g., in about 0-60 seconds).

In an example embodiment, the heating and cooling process for the in-situ polymerization may be carried out by controlling a temperature of a mold. That is, after the thermoplastic resin composition is mixed with nanocarbons to obtain a mixture, which in turn is applied onto the substrate film. Then, the resultant laminate is introduced to a mold, and the mold is heated rapidly to a temperature ranging from 150° C. to 260° C. within a short time greater than 0 second to 30 seconds and maintained at the same temperature range for 1 minute to 24 hours. After that, the mold may be cooled rapidly for a time greater than 0 second to 60 seconds. For example, the heating rate or cooling rate may be 40° C.-50° C. per second.

In an example embodiment, the mold may be heated to a temperature of 230° C. and maintained at this temperature for 10 minutes.

When the mold is heated rapidly, maintained for a predetermined time and cooled for a short time as described above, it is possible to produce a heat-dissipating sheet at a high speed, which is favorable to mass production of a flexible heat-dissipating sheet including a composite layer of filler and polymer resin. In addition, since only the mold is cooled rapidly, factors that would affect the physical properties of the resultant product may be blocked, and thus it is more advantageous to provide composites with uniform physical properties.

In an example embodiment, during the production of heat-dissipating sheet, hot pressing may be carried out by applying pressure as well as heat. Such hot pressing may be carried out in a hot press mold.

According to a heat-dissipating sheet obtained as described above, it is possible to disperse nanocarbons (fillers) homogeneously into the composite layer of heat-dissipating sheet, even when the content of nanocarbons (fillers) is high (e.g. 30 wt % or more). Particularly, when powdery nanocarbons (powdery fillers) are mixed with powdery thermoplastic resin composition in which polymerization catalyst and polymerizable thermoplastic resin are dispersed and mixed), i.e., powder mixing is carried out, and then in-situ polymerization is performed, then it is in particular advantageous to disperse nanocarbons (fillers) very homogeneously into the composite layer of heat-dissipating sheet even in case of a high content of nanocarbons (fillers). In this manner, it is possible to improve the physical properties of the final flexible heat-dissipating sheet. Particularly, it is possible to improve the heat conductivity significantly.

According to the above described methods, since a high content of fillers may be dispersed homogeneously in the polymer resin composite layer of heat-dissipating sheet, it is possible to improve the physical properties of the final flexible heat-dissipating sheet including a composite layer of filler and polymer resin. Particularly, the heat conductivity is improved significantly.

For example, the resultant heat-dissipating sheet including a composite layer of filler and polymer resin may have a high in-plane heat conductivity (at least 20 W/m·K).

In addition, the resultant heat-dissipating sheet may be used in heat-dissipating industrial fields, including LED heat-dissipating structures, casings for notebook computers, cellular phones and heat sinks, etc.

### Examples

The examples and experiments will now be described. The following examples and experiments are for illustrative purposes only and not intended to limit the scope of the present disclosure.

(1) Preparation of Thermoplastic Resin Composition

To prepare a composite of nanocarbons and polymer resin in this Example, multi-walled carbon nanotubes available from Hanwha Nanotec Corporation and not subjected to special pretreatment are provided. In addition, 0.6 g (amount used per sample) of CBT available from Cyclics Co. is provided as a thermoplastic resin and titanium tetraoxide (TiO₄) as a polymerization catalyst is dispersed and mixed therewith. Titanium tetraoxide is included in an amount of 0.5 mol % of the thermoplastic resin composition.

(2) Production of Heat-Dissipating Sheet

The thermoplastic resin composition is applied uniformly onto the prepared nanocarbons, and the resultant mixture is applied between two sheets of PET films, followed by heating at 230° C., and is subject to hot press molding under a pressure of 20 MPa for 10 minutes to induce polymerization (in-situ polymerization), and then the polymerization is completed. The content of nanocarbons based on the composite layer (nanocarbons+thermoplastic resin) is shown in the following Table 1.

The obtained flexible heat-dissipating sheet including a composite layer of nanocarbons and polymer resin has a thickness of 50 μm. While CBT in the thermoplastic resin composition applied to the nanocarbons is heated and molten, it is impregnated into the nanocarbons as well as interdiffused to the PET film, and then is polymerized into PBT and is adhered to the PET films at the same time. Thus, the obtained heat dissipating sheet may include an interdiffused phase of PET resin and PBT resin between the composite layer and substrate PET film.

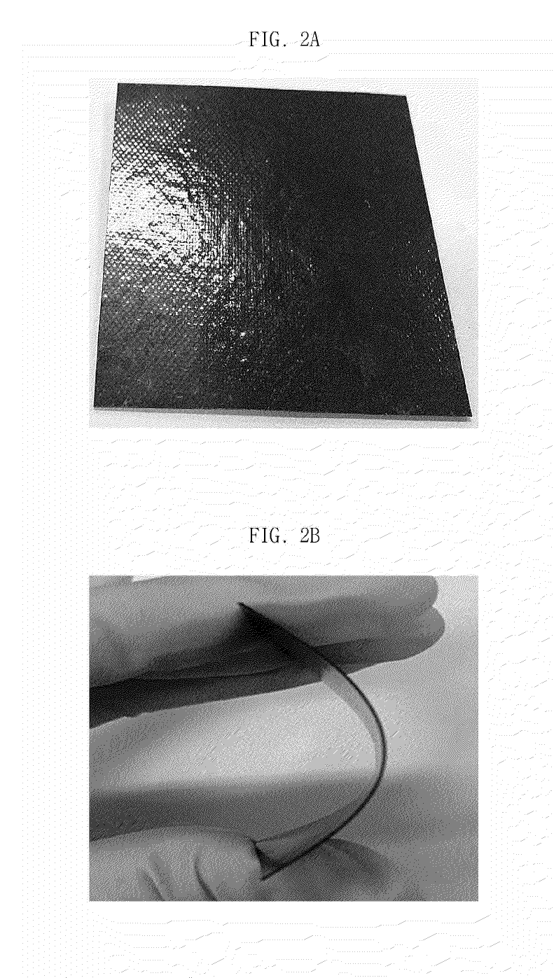

For reference, FIG. 2A illustrates the heat-dissipating sheet according to Example, and FIG. 2B illustrates the flexibility of the heat-dissipated sheet.

(3) Physical Properties of Heat-Dissipating Sheet

The electroconductivity and heat conductivity of the heat-dissipating sheet are determined by the 4-point probe method and hot-disk method, respectively. In addition, the mechanical properties of a heat-dissipating sheet are determined by using a multi-purpose tensile tester. Table 1 shows the electroconductivity, heat conductivity and tensile strength of the heat-dissipating sheet according to the content of nanocarbons included in the composite layer.

TABLE 1

| | | | Tensile |
|---|---|---|---|
| Carbon | Electroconductivity | Heat conductivity | strength |
| nanotubes (wt %) | (S/m) | (W/m · K) | (MPa) |
| 10 | 0.0001 | 3.2 | 166 |
| 30 | 0.01 | 5.7 | 180 |
| 50 | 10000 | 10.7 | 196 |
| 70 | 11500 | 22.4 | 195 |
| 90 | 12000 | 35.0 | 201 |

As can be seen from Table 1, the electrical, thermal and mechanical properties of the finally obtained heat-dissipating sheet are improved in proportion to the content of nanocarbon fillers included in the composite layer. For example, at a nanocarbon content of 90 wt %, excellent electroconductivity of 12000 S/m, heat conductivity of 35 W/m K and tensile strength of 201 MPa are shown.

As can be seen from the foregoing, the heat-dissipating sheet disclosed herein not only has better physical properties as compared to continuated materials such as bucky paper or reduced graphene oxide paper, etc. but also is more suitable for mass production as compared to highly conductive materials for which no mass production technology is established. In addition, according to the present disclosure, production cost may be significantly decreased.

What is claimed is:

1. A heat-dissipating sheet including a composite layer of filler and polymer resin, comprising:
a substrate film; and
a composite layer provided on the substrate film and comprising fillers and polymer resin,
wherein the polymer resin is a polymer of a polymerizable thermoplastic resin, and the polymerizable thermoplastic resin has a property of decreasing in melt viscosity during a polymerization.

2. The heat-dissipating sheet according to claim 1, wherein the heat-dissipating sheet comprises the composite layer between two substrate films.

3. The heat-dissipating sheet according to claim 1, wherein the fillers are included in an amount of 10-95 wt % based on the composite layer.

4. The heat-dissipating sheet according to claim 1, wherein the fillers are included in an amount of 30-95 wt % based on the composite layer.

5. The heat-dissipating sheet according to claim 1, wherein the fillers are included in an amount of 50-95 wt % based on the composite layer.

6. The heat-dissipating sheet according to claim 1, wherein the heat-dissipating sheet has a 2% or less filler composition uniformity.

7. The heat-dissipating sheet according to claim 1, wherein the substrate film consists essentially of a resin compatible with the polymer resin.

8. The heat-dissipating sheet according to claim 1, wherein the heat-dissipating sheet has an interdiffused phase consisting of the polymer resin and a resin of the substrate film between the composite layer and the substrate film.

9. The heat-dissipating sheet according to claim 1, wherein the polymer resin is polybutylene terephthalate (PBT) and a resin of the substrate film is polyethylene terephthalate.

10. The heat-dissipating sheet according to claim 1, wherein the fillers are at least one selected from the group consisting of metallic fillers, ceramic fillers and carbon fillers.

11. The heat-dissipating sheet according to claim 1, wherein the fillers are carbon fillers.

12. The heat-dissipating sheet according to claim 11, wherein the carbon fillers are nanocarbons.

13. The heat-dissipating sheet according to claim 1, wherein the filler are powdery fillers.

14. The heat-dissipating sheet according to claim 1, wherein the substrate film is a flexible substrate film.

15. The heat-dissipating sheet according to claim 1, wherein the heat-dissipating sheet has a heat conductivity of at least 20 W/m·K.

16. The heat-dissipating sheet according to claim 1, wherein the heat-dissipating sheet has a tensile strength of at least 200 MPa.
